(19) United States
(12) Patent Application Publication
(10) Pub. No.: US 2023/0237553 A1
(43) Pub. Date: Jul. 27, 2023

(54) USE OF ELICITED FACTORS TO INFORM INTERVENTION SUGGESTIONS

(71) Applicant: TOYOTA RESEARCH INSTITUTE, INC., Los Altos, CA (US)

(72) Inventors: Francine R. CHEN, Menlo Park, CA (US); Nikos ARECHIGA GONZALEZ, San Mateo, CA (US); Emily Sarah SUMNER, Berkeley, CA (US); Rumen ILIEV, Milbrae, CA (US); Scott CARTER, San Jose, CA (US)

(73) Assignee: TOYOTA RESEARCH INSTITUTE, INC., Los Altos, CA (US)

(21) Appl. No.: 17/946,981

(22) Filed: Sep. 16, 2022

Related U.S. Application Data
(60) Provisional application No. 63/303,432, filed on Jan. 26, 2022.

(51) Int. Cl. G06Q 30/06; G06Q 30/02

(52) U.S. Cl. CPC G06Q 30/0631; G06Q 30/0269

(57) ABSTRACT

A method for use of elicited factors to inform intervention suggestions is described. The method includes identifying a demographic of a user according to a background of the user. The method also includes predicting factors including an associated set of barriers and/or motivators regarding a preference according to the demographic of the user. The method further includes predicting a plurality of interventions to shift the preference of the user according to the associated set of barriers and/or motivators. The method also includes presenting a selected one of the plurality of determined interventions to the user.

### CROSS-REFERENCE TO RELATED APPLICATION

The present application claims the benefit of U.S. Provisional Patent Application No. 63/303,432, filed Jan. 26, 2022, and titled “USE OF ELICITED FACTORS TO INFORM INTERVENTION SUGGESTIONS,” the disclosure of which is expressly incorporated by reference in its entirety.

### BACKGROUND

### Field

Certain aspects of the present disclosure generally relate to machine learning and, more particularly, to a system and method for using elicited factors to inform intervention suggestions.

### Background

Internet websites visited by users display products of interest according to inferences from user interactions. For example, the inferences include previously presented products, viewed products, or purchased products. Through many interactions, a user profile becomes richer through each interaction. As such, the predictions for selling products to users and/or using products by users improves. Over time, this user profile generally indicates the user's preferences for certain products. The user's preferences, however, can change.

Adapting to a changing world may involve behavioral changes regarding user preferences. For example behavioral changes may be necessary for combating environmental changes to save the world. While there are multiple approaches for implementing behavioral changes, a behavioral change technique using cognitive intervention is desired. In particular, a system that changes preference with few interactions and provides feedback about a preference shift is desired.

### SUMMARY

A method for use of elicited factors to inform intervention suggestions is described. The method includes identifying a demographic of a user according to a background of the user. The method also includes predicting factors including an associated set of barriers and/or motivators regarding a preference according to the demographic of the user. The method further includes predicting a plurality of interventions to shift the preference of the user according to the associated set of barriers and/or motivators. The method also includes presenting a selected one of the plurality of determined interventions to the user.

A non-transitory computer-readable medium having program code recorded thereon for use of elicited factors to inform intervention suggestions is described. The program code is executed by a processor. The non-transitory computer-readable medium includes program code to identify a demographic of a user according to a background of the user. The non-transitory computer-readable medium also includes program code to predict factors including an associated set of barriers and/or motivators regarding a preference according to the demographic of the user. The non-transitory computer-readable medium further includes program code to predict a plurality of interventions to shift the preference of the user according to the associated set of barriers and/or motivators. The non-transitory computer-readable medium also includes program code to present a selected one of the plurality of determined interventions to the user.

A system for use of elicited factors to inform intervention suggestions is described. The system includes a demographic identification module to identify a demographic of a user according to a background of the user, The system also includes a factor prediction model to predict factors including an associated set of barriers and/or motivators regarding a preference according to the demographic of the user. The system further includes an intervention prediction model to predict a plurality of interventions to shift the preference of the user according to the associated set of barriers and/or motivators. The system also includes an intervention presentation module to present a selected one of the plurality of determined interventions to the user.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC) of a preference monitoring and intervention system, in accordance with aspects of the present disclosure.

FIG. 2 is a block diagram illustrating an exemplary software architecture that may modularize artificial intelligence (AI) functions for a preference monitoring and intervention system, according to aspects of the present disclosure.

FIG. 3 is a diagram illustrating a hardware implementation for a preference monitoring and intervention system, according to aspects of the present disclosure.

FIG. 4 is a block diagram illustrating a preference monitoring and intervention system, in accordance with aspects of the present disclosure.

FIG. 5 is a flowchart illustrating a method for preference monitoring and intervention, according to aspects of the present disclosure.

FIG. 6 is a flowchart illustrating a method for use of elicited factors to inform intervention suggestions, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Electric vehicle development is at an all-time high, prompting large and small original equipment manufacturers (OEM) to manufacture electrical propulsion vehicles. The term electric vehicle covers several types of electric vehicle (EVs). EVs use electricity for some of their operation, and may include the following main types. For example, one type of EV is a hybrid electric vehicle (HEV), which uses a fuel-based engine and an electric motor powered by a battery. HEVs begin operation under electric power, then the gas engine operates once the vehicle achieves a desired speed, as determined by an onboard computer system. HEVs do not rely on a plug-in for charging, which is performed through a process known as “regenerative braking.”

A plug-in hybrid electric vehicle (PHEV) is another type of EV, which is a cross between a battery electric vehicle (BEV) and an HEV. A PHEV incudes an electric motor that is recharged via an external plug and, similar to the HEV, a PHEV includes a fuel-based internal combustion engine (ICE). A difference between an HEV and a PHEV is that the PHEV can travel on electric power alone using a battery with the ability to recharge from a power grid. By contrast, BEVs do not include an ICE and are powered entirely by electricity. Instead, BEVs include electric motors powered by an onboard battery, which is charged via an external outlet.

People generally think positively about BEVs and are possibly interested in buying a BEV in the future; however, they have many uncertainties and unknowns that need to be addressed before buying a BEV for themselves. There are a variety of concerns and beliefs about BEV ownership that contribute to this uncertainty, such as ownership cost, limited range, availability of charging, and social and safety factors. These concerns and beliefs can be due to misperceptions about BEVs or not being aware of facts. Some people who live in a house may believe that charging is inconvenient, and they may not know that BEVs are less expensive to maintain than internal combustion engine vehicles (ICEVs).

Because people have a variety of concerns, and there are many possible interventions to address the range of concerns, interventions vary in their suitability and effectiveness for a particular individual. Identifying personalized interventions for an individual is an important task. In particular, interventions that do not consider the demographic background of individual consumers may produce the reverse effect; namely, strengthening opposition to electric vehicles. Consequently, when there are many interventions that could be presented, it is important to present the most relevant interventions to a person, rather than showing a fixed set of interventions, which may not address their concerns.

Some aspects of the present disclosure are directed to methods for personalizing interventions based on an individual's demographic to shift the preferences of consumers to be more positive towards BEVs. One of the constraints in building models to suggest interventions for shifting preferences is that each intervention can influence the effectiveness of later interventions. This, in turn, involves many subjects to evaluate effectiveness of each possible intervention. To address this, some aspects of the present disclosure identify personalized factors influencing BEV adoption, such as barriers and motivators. This method for predicting these factors exhibits a performance better than always predicting the most frequent factors. In some aspects of the present disclosure, a reinforcement learning (RL) model learns the most effective interventions, and compares the number of subjects specified for each approach.

In some aspects of the present disclosure, a system integrates user profiles (e.g., demographics) to predict barriers and motivators. In these aspects of the present disclosure, the predictions are used to identify personalized interventions for a subject using human expertise. In these aspects of the present disclosure, the system trains a model to predict factors (e.g., barriers and motivators) from user profiles (e.g., demographic information) by eliciting, thereby avoiding explicitly asking or questioning the user. Beneficially, the system can predict interventions to help users change preferences towards acceptance or adoption of an idea or product. In one aspect of the present disclosure, the system is used by a reinforcement learning model as input features or used for synthesizing data during model initialization.

In some aspects of the present disclosure, the system addresses training an intervention model when the number of users or an amount of data is limited. The system specifies less user data for training a model to predict interventions that are presented with little training for intervention effects on a preference. This is useful where a subject can rate only a small number of interventions. In one aspect of the present disclosure, the system uses human expertise to define the factors and the appropriate interventions for each factor. In this example, the system avoids learning the best interventions from a limited number of subjects.

In one aspect of the present disclosure, the system assesses the effect of an intervention for shifting user preferences, such as towards battery-electric vehicles (BEVs) or plug-in hybrid electric vehicles (PHEVs). For example, the system may ask a person directly about a preference or show a task for indirect assessment. Each presented intervention can affect user preferences. For example, the effect may tend to decrease with each presented intervention. Thus, a system running enough subjects to assess each intervention for the different backgrounds can determine the effect of an intervention.

Some aspects of the present disclosure examine methods for identifying persuasive interventions for each individual given their background. These aspects of the present disclosure use demographic information about an individual to provide a background context. This information may be gathered through a survey/questionnaire. One of the difficulties in predictions based on survey data from human subjects is the limited dataset size for training and testing a model. To overcome these deficiencies, a first approach integrates human knowledge with supervised machine learning for predicting barriers to reduce the number of subjects needed for training a model. Interventions to address the identified barriers can then be presented to a subject. For this approach, the experiments are performed on a dataset collected from the survey. In the second approach, reinforcement learning (RL) is used to directly learn which interventions are most effective.

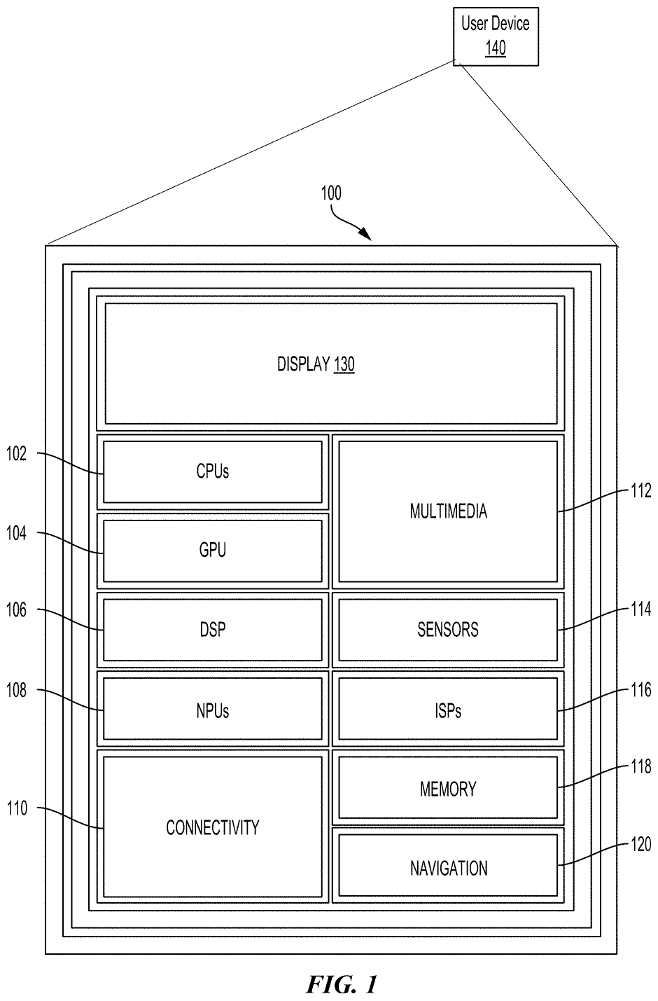

FIG. 1 illustrates an example implementation of the aforementioned system and method for a preference monitoring and intervention system using a system-on-a-chip (SOC) 100, according to aspects of the present disclosure. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, select a control action, according to the display 130 illustrating a view of a user device.

In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system. The SOC 100 may be based on an Advanced Risk Machine (ARM) instruction set or the like. In another aspect of the present disclosure, the SOC 100 may be a server computer in communication with a user device 140. In this arrangement, the user device 140 may include a processor and other features of the SOC 100.

In this aspect of the present disclosure, instructions loaded into a processor (e.g., CPU 102) or the NPU 108 of the user device 140 may include code to use elicited factors for informing intervention suggestions regarding a user preference. The instructions loaded into a processor (e.g., NPU 108) may also include code to identify a demographic of a user according to a background of the user. The instructions loaded into a processor (e.g., NPU 108) may also include code to predict factors including an associated set of barriers and/or motivators regarding a user preference according to the demographic of the user. The instructions loaded into a processor (e.g., NPU 108) may also include code to predict a plurality of interventions to shift a preference of the user according to the associated set of barriers and/or motivators. The instructions loaded into a processor (e.g., NPU 108) may also include code to present a selected one of the plurality of determined interventions to the user.

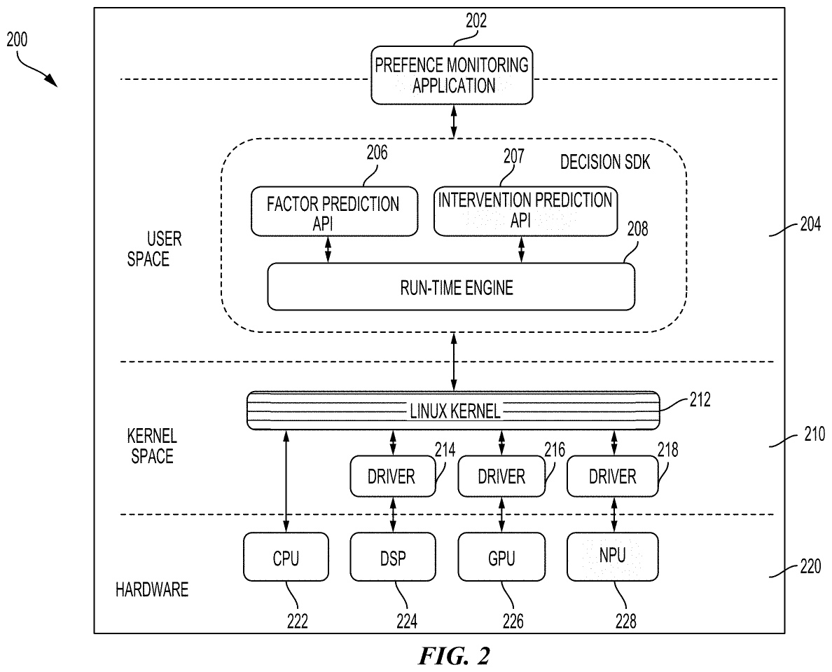

FIG. 2 is a block diagram illustrating a software architecture 200 that may modularize artificial intelligence (AI) functions for a preference monitoring and intervention system, according to aspects of the present disclosure. Using the architecture, a preference monitoring application 202 may be designed such that it may cause various processing blocks of an SOC 220 (for example a CPU 222, a DSP 224, a GPU 226, and/or an NPU 228) to perform supporting computations during run-time operation of the preference monitoring application 202. While FIG. 2 describes the software architecture 200 for preference monitoring and intervention, it should be recognized that the preference monitoring and intervention system is not limited to preferences involving battery electric vehicles (BEVs). According to aspects of the present disclosure, the preference monitoring and intervention functionality is applicable to any type of user preference for a product or an activity.

The preference monitoring application 202 may be configured to call functions defined in a user space 204 that may, for example, provide for user activity and decision monitoring services. The preference monitoring application 202 may make a request for compiled program code associated with a library defined in a factor prediction application programming interface (API) 206. The factor prediction API 206 is configured to predict factors including an associated set of barriers and/or motivators regarding a preference according to the demographic of the user. In response, compiled code of an intervention prediction API 207 is configured to predict a set of interventions to shift a preference of the user according to the associated set of barriers and/or motivators. In addition, the intervention prediction API 207 is configured to present a selected one of the set of determined interventions to the user.

A run-time engine 208, which may be compiled code of a run-time framework, may be further accessible to the preference monitoring application 202. The preference monitoring application 202 may cause the run-time engine 208, for example, to take actions for providing predicted intervention in response to predicted barriers and/or motivators regarding a user preference. In response to a negative user preference, the run-time engine 208 may in turn send a signal to an operating system 210, such as a Linux Kernel 212, running on the SOC 220. FIG. 2 illustrates the Linux Kernel 212 as software architecture for preference monitoring and intervention. It should be recognized, however, that aspects of the present disclosure are not limited to this exemplary software architecture. For example, other kernels may provide the software architecture to support preference monitoring and intervention functionality.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228, if present.

People generally think positively about battery electric vehicles (BEVs) and are possibly interested in buying a BEV in the future; however, they have many uncertainties and unknowns that need to be addressed before buying a BEV for themselves. There are a variety of concerns and beliefs about BEV ownership that contribute to this uncertainty, such as ownership cost, limited range, availability of charging, and social and safety factors. These concerns and beliefs can be due to misperceptions about BEVs or not being aware of facts. Some people who live in a house may believe that charging is inconvenient, and they may not know that BEVs are less expensive to maintain than internal combustion engine vehicles (ICEVs).

Because people have a variety of concerns, and there are many possible interventions to address the range of concerns, interventions vary in their suitability and effectiveness for a particular individual. Identifying personalized interventions for an individual is an important task. In particular, interventions that do not consider the demographic background of individual consumers may produce the reverse effect, i.e., strengthening opposition to electric vehicles. Consequently, when there are many interventions that could be presented, it is important to present the most relevant interventions to a person, rather than showing a fixed set of interventions, which may not address their concerns.

Some aspects of the present disclosure examine methods for identifying persuasive interventions for each individual given their background. These aspects of the present disclosure use demographic information about an individual to provide a background context. This information may be gathered through a survey/questionnaire. One of the difficulties in predictions based on survey data from human subjects is the limited dataset size for training and testing a model. To overcome these deficiencies, a first approach integrates human knowledge with supervised machine learning for predicting barriers to reduce the number of subjects needed for training a model. Interventions to address the identified barriers can then be presented to a subject. For this approach, the experiments are performed on a dataset collected from the survey. In the second approach, reinforcement learning (RL) is used to directly learn which interventions are most effective.

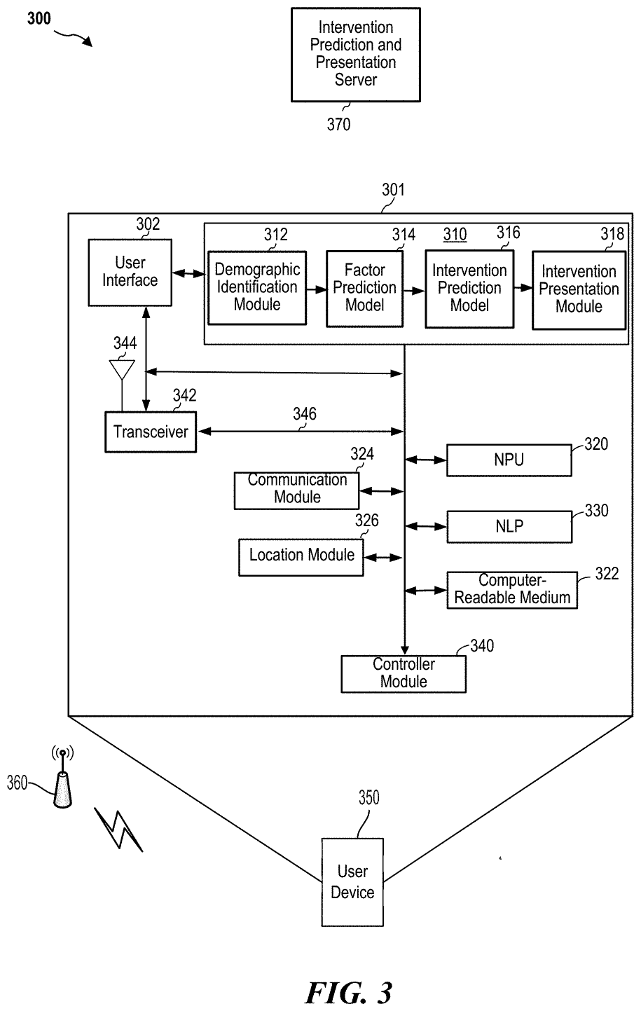

FIG. 3 is a diagram illustrating a hardware implementation for a preference monitoring and intervention system 300, according to aspects of the present disclosure. The preference monitoring and intervention system 300 may be configured to use elicited factors for informing intervention suggestions regarding a user preference. The preference monitoring and intervention system 300 is also configured to identify a demographic of a user according to a background of the user. In response, the preference monitoring and intervention system 300 is configured to predict factors including an associated set of barriers and/or motivators regarding a user preference according to the demographic of the user. In addition, the preference monitoring and intervention system 300 is configured to predict a set of interventions to shift a preference of the user according to the associated set of barriers and/or motivators by presenting a selected one of the set of determined interventions to the user.

The preference monitoring and intervention system 300 includes a user monitoring system 301 and an intervention prediction and presentation server 370 in this aspect of the present disclosure. The user monitoring system 301 may be a component of a user device 350. The user device 350 may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a Smartbook, an Ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a global positioning system device, or any other suitable device that is configured to communicate via a wireless or wired medium.

The intervention prediction and presentation server 370 may connect to the user device 350 for providing interventions to affect a user preference. For example, the intervention prediction and presentation server 370 may examine methods for identifying persuasive interventions for various individuals given their background. These aspects of the present disclosure use demographic information about an individual to provide a background context. This information may be gathered through a survey/questionnaire. In some aspects of the present disclosure, the intervention prediction and presentation server 370 integrates human knowledge with supervised machine learning for predicting barriers to reduce the number of subjects needed for training a model. Interventions to address the identified barriers can then be presented to a subject. For this approach, the experiments are performed on a dataset collected from the survey. In some aspects of the present disclosure, the intervention prediction and presentation server 370 uses reinforcement learning (RL) to directly learn which interventions are most effective.

The user monitoring system 301 may be implemented with an interconnected architecture, represented generally by an interconnect 346. The interconnect 346 may include any number of point-to-point interconnects, buses, and/or bridges depending on the specific application of the user monitoring system 301 and the overall design constraints. The interconnect 346 links together various circuits including one or more processors and/or hardware modules, represented by a user interface 302, a user activity module 310, a neutral network processor (NPU) 320, a computer-readable medium 322, a communication module 324, a location module 326, a natural language processor (NLP) 330, and a controller module 340. The interconnect 346 may also link various other circuits such as timing sources, peripherals, voltage regulators, and power management circuits, which are well known in the art, and therefore, will not be described any further.

The user monitoring system 301 includes a transceiver 342 coupled to the user interface 302, the user activity module 310, the NPU 320, the computer-readable medium 322, the communication module 324, the location module 326, the NLP 330, and the controller module 340. The transceiver 342 is coupled to an antenna 344. The transceiver 342 communicates with various other devices over a transmission medium. For example, the transceiver 342 may receive commands via transmissions from a user or a connected vehicle. In this example, the transceiver 342 may receive/transmit information for the user activity module 310 to/from connected devices within the vicinity of the user device 350.

The user monitoring system 301 includes the NPU 320 coupled to the computer-readable medium 322. The NPU 320 performs processing, including the execution of software stored on the computer-readable medium 322 to provide a neural network model for user monitoring and advice recommendation functionality according to the present disclosure. The software, when executed by the NPU 320, causes the user monitoring system 301 to perform the various functions described for preference monitoring and intervention through the user device 350, or any of the modules (e.g., 310, 324, 326, 330, and/or 340). The computer-readable medium 322 may also be used for storing data that is manipulated by the NLP 330 when executing the software to analyze user communications.

The location module 326 may determine a location of the user device 350. For example, the location module 326 may use a global positioning system (GPS) to determine the location of the user device 350. The location module 326 may implement a dedicated short-range communication (DSRC)-compliant GPS unit. A DSRC-compliant GPS unit includes hardware and software to make the autonomous vehicle 350 and/or the location module 326 compliant with the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

The communication module 324 may facilitate communications via the transceiver 342. For example, the communication module 324 may be configured to provide communication capabilities via different wireless protocols, such as 6G, 5G new radio (NR), Wi-Fi, long term evolution (LTE), 4G, 3G, etc. The communication module 324 may also communicate with other components of the user device 350 that are not modules of the user monitoring system 301. The transceiver 342 may be a communications channel through a network access point 360. The communications channel may include DSRC, 5G NR, 6G, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

The user monitoring system 301 also includes the NLP 330 to receive and analyze language from user communications to determine the user information. For example, the user's preference status may indicate barriers regarding a user's preference. The user monitoring system 301 may use the NLP 330 to extract terms from communications regarding user demographics, motivators and barriers for determining interventions to alter a user's preference. The NLP 330 may receive and analyze the communications to determine the user's concerns around a preferences, such as risks and costs. For example, user may believe that charging a battery electric vehicle (BEV) is inconvenient, and may not realize that BEVs are less expensive to maintain than internal combustion engine vehicles (ICEVs).

The user activity module 310 may be in communication with the user interface 302, the NPU 320, the computer-readable medium 322, the communication module 324, the location module 326, the NLP 330, the controller module 340, and the transceiver 342. In one configuration, the user activity module 310 monitors communications from the user interface 302. The user interface 302 may monitor user communications to and from the communication module 324. According to aspects of the present disclosure, the NLP 330 may use natural language processing to extract terms from communications regarding user preference, such as terms revealing that the user believes certain barriers exist for owns a BEV.

As shown in FIG. 3, the user activity module 310 includes a demographic identification module 312, a factor prediction model 314, an intervention prediction model 316, and an intervention presentation module 318. The factor prediction model 314 and the intervention prediction model 316 may be components of a same or different support vector machine (SVM). The factor prediction model 314 and the intervention prediction model 316 are not limited to a SVM. The user activity module 310 monitors and analyzes user communications received from the user interface 302.

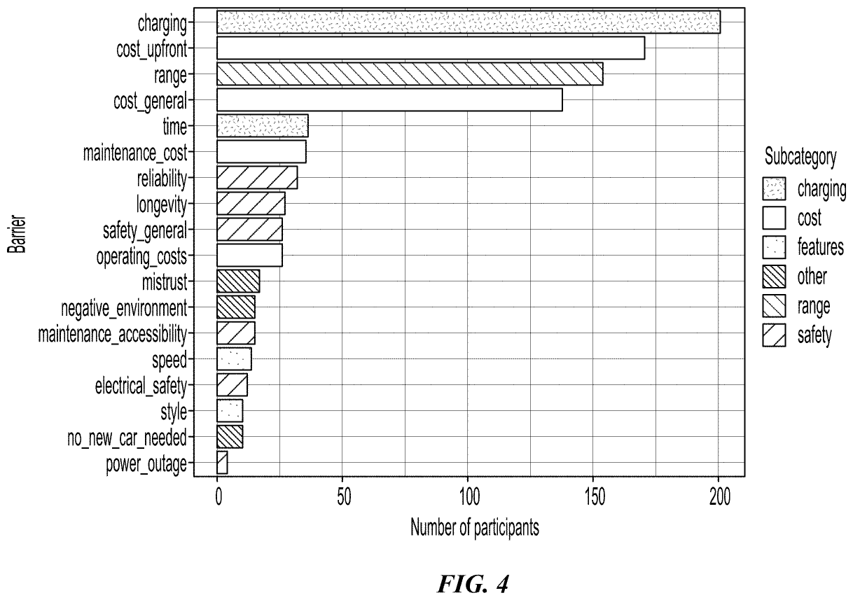

This configuration of the user activity module 310 includes the demographic identification module 312 for identifying a demographic of a user according to a background of the user through the user device 350. The user activity module 310 also includes the factor prediction model 314 for predicting factors including an associated set of barriers and/or motivators regarding a preference according to the demographic of the user. The user activity module 310 also includes the intervention prediction model 316 for predicting interventions to shift a preference of the user according to the associated set of barriers and/or motivators. The user activity module 310 further includes intervention presentation module 318 for presenting a selected one of the determined interventions to the user, for example, as shown in FIG. 4. In some aspects of the present disclosure, the user activity module 310 may be implemented and/or work in conjunction with the intervention prediction and presentation server 370.

FIG. 4 is a bar graph illustrating barriers affecting a user's preference toward battery electric vehicles (BEVs) or plug-in hybrid electric vehicles (PHEVs). Some aspects of the present disclosure are directed to predicting intervention for overcoming the barriers shown in FIG. 4. In practice, the effect of an intervention in shifting a person's preferences, such as towards BEVs or PHEVs, can be assessed by either asking a person directly about their preference or showing them a task to indirectly assess. For example, one question may involve building a car on a website and observing whether they choose to build a BEV, PHEV, hybrid, or internal combustion engine (ICE) vehicle. Each presented intervention can affect a person's preferences, but the effect of an intervention tends to decrease with each presented intervention. Thus it can be difficult to run enough subjects to assess each intervention for the different backgrounds that can influence the effect of an intervention.

Some aspects of the present disclosure are directed to an alternative, indirect approach of using elicited factors to predict personalized interventions that might be most effective for a given individual. Many factors can be assessed per person, thus reducing the number of subjects needed. These aspects of the present disclosure hypothesize that factors such as barriers and motivators towards a vehicle engine preference can inform the prediction of interventions. Examples of barriers are shown in FIG. 4. Because such factors are elicited from a person, each person can provide information about their set of barriers, enabling collection of information about the best type of intervention for each person. This contrasts with the constraint of asking a person about the effect of only one intervention or a small number of interventions.

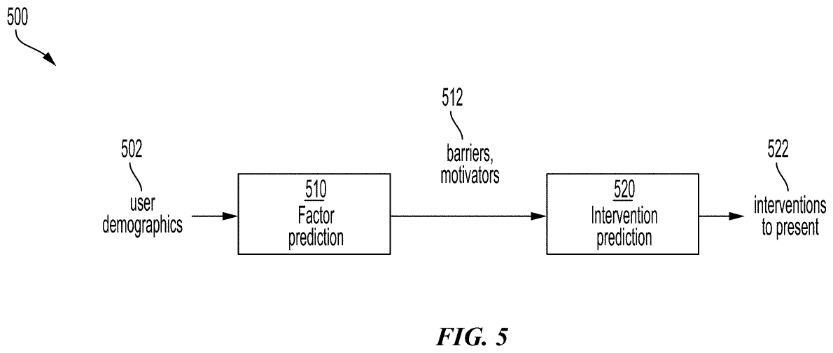

FIG. 5 is a block diagram illustrating a preference monitoring and intervention system, according to aspects of the present disclosure. Factors such as barriers and motivators towards a preference can improve a model predicting the most effective intervention. The system collects information about ideal intervention types because the factors are elicited from each person. This provides information about a set of barriers and motivators for a preference. This contrasts with asking a person about the effect of one intervention or a small number of interventions. In some aspects of the present disclosure, the factors are predicted and ranked for each person according to demographics. The system can use the identified factors to filter or select an intervention for presentation to the user for shifting a user's preference, such as purchasing a battery electric vehicle (BEV), plug-in hybrid electric vehicle (PHEV), or other like electric vehicle.

As shown FIG. 5, the preference monitoring and intervention system 500 identifies a demographic 502 of a user according to a background of the user. Some aspects of the present disclosure identify persuasive interventions for each individual given their background. These aspects of the present disclosure use demographic information about an individual to provide a background context. At block 510, the preference monitoring and intervention system 500 predicts factors including an associated set of barriers and/or motivators 512 regarding a preference according to the demographic 502 of the user.

At block 520, the preference monitoring and intervention system 500 predicts interventions to shift a preference of the user according to the associated set of barriers and/or motivators. In various implementations, the preference monitoring and intervention system 500 manually defines the interventions and uses the factor that the intervention addresses for selection. In addition, the preference monitoring and intervention system 500 can assess the effectiveness of each intervention (e.g., as measured by a preference shift) by presenting interventions per subject and the effectiveness of the intervention used for a predicted barrier. At block 522, the preference monitoring and intervention system 500 presents a selected one of the determined interventions to the user.

As an example, the preference monitoring and intervention system 500 may consider factors that are barriers to BEV acceptance (e.g., price, range, charging availability, etc.). In some aspects of the present disclosure, the preference monitoring and intervention system 500 identifies BEV factors through literature reviews or surveys. In these aspects of the present disclosure, a learning model predicts a score indicating the likelihood each factor is a barrier for a profile (e.g., by demographics, income, geographic area, etc.). The set of possible factors have an associated score or probability that can be used to rank the factors (e.g., vehicle purchase price: 1.2, range: 0.9, charging availability: 0.5, maintenance costs: −1.1, etc.).

Assuming sparse training data, the preference monitoring and intervention system 500 may train the learning model as a one-vs-rest support vector machine for each factor. In one approach, each model uses the same kernel to allow ranking of the factors according to a score. In some aspects of the present disclosure, the preference monitoring and intervention system 500 uses different approaches for using the scored factors and interventions, including determining an order. For example, according to a first methodology (Method A), for the highest-ranked barrier, the preference monitoring and intervention system 500 presents the highest-ranked intervention for that barrier. The preference monitoring and intervention system 500 continues to the next barrier until a score threshold or the maximum number of interventions is reached. When a score threshold is reached, the preference monitoring and intervention system 500 may start with the highest-ranked barrier again.

In some aspects of the present disclosure, the preference monitoring and intervention system 500 operates according to a second methodology (Method B). In some aspects of the present disclosure, the second methodology combines the barrier and the intervention scores (e.g., by multiplication) and then ranks all the interventions and operates according to the first methodology. According to a third methodology (Method C), the preference monitoring and intervention system 500 collects the presented intervention, the preference change after an intervention for each subject, and demographics or background. Next the preference monitoring and intervention system 500 ranks the interventions according to this information and follows the first methodology.

Some aspects of the present disclosure configure the preference monitoring and intervention system 500 to integrate user profiles (e.g., demographics) for predicting barriers and motivators through a learning model. These predictions may be used to identify personalized interventions for a subject using human expertise. In these aspects of the present disclosure, the preference monitoring and intervention system 500 trains the model (e.g., the factor prediction model 314 of FIG. 3) to predict factors (e.g., barriers and motivators elicited from subjects) from user profiles (e.g., demographic information), while avoiding explicit questioning. As such, the preference monitoring and intervention system 500 predicts interventions (e.g., using the intervention prediction model 316 of FIG. 3) to help users change preferences towards acceptance or adoption of an idea or product with little training.

In some aspects of the present disclosure, the preference monitoring and intervention system 500 presents one intervention at a time to a subject, which specifies ranking the interventions. For example, the interventions may be ranked to determine the presentation order, rather than simply classifying to determine whether to present the intervention. In some aspects of the present disclosure, the rank of an intervention roughly corresponds to the importance of the barrier that the intervention addresses. According to these aspects of the present disclosure, the barriers are predicted and ranked for each person, where the predictions are based on a subject's demographics. Referring again to FIG. 4, a total of 18 barriers are listed for prediction in a multi-label task. In some aspects of the present disclosure, a model for the factor prediction of block 510 and the intervention prediction of block 520 of FIG. 5 may be implemented using two models: (1) simple multi-layer perceptron (MLP), (2) a support vector machine (SVM), or other like prediction model.

One configuration of an MLP to implement the models for the factor prediction and the intervention prediction of blocks 510 and 520 includes three (3) layers with a logistic activation function and ten nodes. An output layer of the MLP may operate by using a softmax nonlinearity, where each of ten nodes corresponded to a barrier. In these aspects of the present disclosure, the MLP performs multi-label classification using a mean squared error loss. Another configuration uses an SVM to implement the models for the factor prediction and the intervention prediction of blocks 510 and 520 with a small dataset size. To handle the multi-label classification task, a one-vs-rest model was used for each of the 18 barriers.

From the predicted barriers, the interventions that best address those barriers can then be identified by the preference monitoring and intervention system 500 for presentation to a user, as shown in FIG. 5. The interventions may be manually defined by experts in Behavioral Science and for rich modalities, also by experts in Human Computer Interaction. If there are multiple interventions for a barrier, a study to assess the effectiveness of each intervention (as measured by preference shift) by presenting one or a few interventions per subject can be conducted, and the effectiveness of the intervention can be used when deciding which intervention to present for a predicted barrier.

Some aspects of the present disclosure learn to recommend interventions using a reinforcement learning model to learn the best intervention for each user. Since reinforcement learning approaches are data-hungry and participant data is expensive to gather, some aspects of the present disclosure run an initial data-gathering survey to inform simulation models. These simulation models are then used to pre-train reinforcement learning models, and allow selection of the model that is most likely to perform well in deployment.

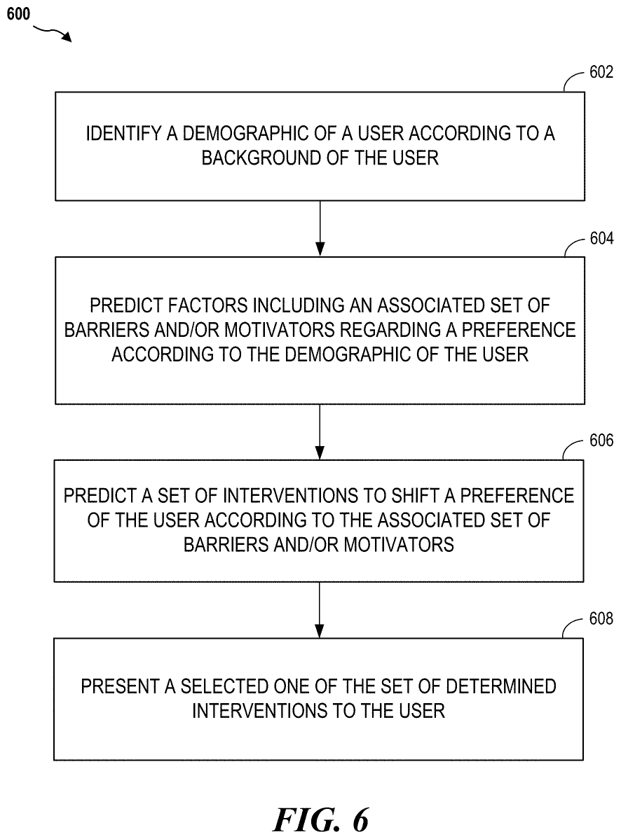

To gather data for these simulation models, subjects participate in a survey to measure intervention effectiveness. At the beginning of the survey, the subjects answered the demographic questions and indicated their initial preferences for BEVs. Then they were randomly exposed to one of the 35 interventions we designed and then they answered the BEV preference question again. A preference changes score was computed as the difference between pre- and post-intervention answers. For each intervention, a mean intervention effectiveness is computed. For example, the mean intervention effectiveness may range from 0.275 to 13.10, with an average of 5.52, and a standard deviation of 2.9. The preference monitoring and intervention system 500 may engage in a process, for example, as shown in FIG. 6.

FIG. 6 is a flowchart illustrating a method for use of elicited factors to inform intervention suggestions, according to aspects of the present disclosure. A method 600 of FIG. 6 begins at block 602, in which a demographic of a user is identified according to a background of the user. For example, as shown in FIG. 5, the preference monitoring and intervention system 500 identifies the demographic 502 (e.g., by income, geographic area, etc.) of the user according to the background of the user. Some aspects of the present disclosure identify persuasive interventions for each individual given their background. These aspects of the present disclosure use demographic information about an individual to provide a background context.

Referring again to FIG. 6, at block 604, factors are predicted, including an associated set of barriers and/or motivators regarding a preference according to the demographic of the user. For example, as shown in FIG. 5, at block 510, the preference monitoring and intervention system 500 predicts factors including an associated set of barriers and/or motivators 512 regarding a preference according to the demographic 502 of the user. In some aspects of the present disclosure, the preference monitoring and intervention system 500 integrates user profiles (e.g., demographics) for predicting barriers and motivators through a learning model. These predictions may be used to identify personalized interventions for a subject using human expertise. In these aspects of the present disclosure, the preference monitoring and intervention system 500 trains a model (e.g., the factor prediction model 314 of FIG. 3) to predict factors (e.g., barriers and motivators elicited from subjects) from user profiles (e.g., demographic information), while avoiding explicit questioning.

At block 606, a set of interventions is predicted to shift a preference of the user according to the associated set of barriers and/or motivators. For example, as shown in FIG. 5, at block 520, the preference monitoring and intervention system 500 predicts interventions to shift a preference of the user according to the associated set of barriers and/or motivators. In various implementations, the preference monitoring and intervention system 500 manually defines the interventions and uses the factor that the intervention addresses for selection. In addition, the preference monitoring and intervention system 500 can assess the effectiveness of each intervention (e.g., as measured by a preference shift) by presenting interventions per subject and the effectiveness of the intervention used for a predicted barrier.

At block 608, a selected one of the set of determined interventions is presented to the user. For example, as shown in FIG. 5, at block 522, the preference monitoring and intervention system 500 presents a selected one of the determined interventions to the user. From the predicted barriers, the interventions that best address those barriers can then be identified by the preference monitoring and intervention system 500 for presentation to a user, as shown in FIG. 5. The interventions may be manually defined by experts in Behavioral Science and for rich modalities, also by experts in Human Computer Interaction. If there are multiple interventions for a barrier, a study to assess the effectiveness of each intervention (as measured by a preference shift) by presenting one or a few interventions per subject can be conducted, and the effectiveness of the intervention can be used when deciding which intervention to present for a predicted barrier.

The method 600 also includes eliciting information regarding the associated set of barriers and/or motivators from other users having the background of the user. The method 600 further includes training a model according to the elicited information to predict the associated set of barriers and/or motivators. The method 600 also includes selecting a highest-ranked barrier. The method 600 further includes presenting a highest-ranked intervention corresponding to the selected barrier. The method 600 also includes selecting a next, highest-ranked barrier. The method 600 further includes presenting the highest-ranked intervention corresponding to the next, selected barrier. The method 600 also includes repeating the selecting and presenting until a score threshold or a maximum number of interventions is reached.

Some aspects of the present disclosure examine methods for identifying persuasive interventions for each individual given their background. These aspects of the present disclosure use demographic information about an individual to provide a background context. This information may be gathered through a survey/questionnaire. One of the difficulties in predictions based on survey data from human subjects is the limited dataset size for training and testing a model. To overcome these deficiencies, a first approach integrates human knowledge with supervised machine learning for predicting barriers to reduce the number of subjects needed for training a model. Interventions to address the identified barriers can then be presented to a subject. For this approach, the experiments are performed on a dataset collected from the survey. In the second approach, reinforcement learning (RL) is used to directly learn which interventions are most effective. These experiments examine the case when no demographic information is available and a limited set of demographic information is available.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM, flash memory, ROM, programmable read-only memory (PROM), EPROM, EEPROM, registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for use of elicited factors to inform intervention suggestions, the method comprising:
identifying a demographic of a user according to a background of the user;
predicting factors including an associated set of barriers and/or motivators regarding a preference according to the demographic of the user;
predicting a plurality of interventions to shift the preference of the user according to the associated set of barriers and/or motivators; and
presenting a selected one of the plurality of determined interventions to the user.

2. The method of claim 1, further comprising:
eliciting information regarding the associated set of barriers and/or motivators from other users having the background of the user; and
training a model according to the elicited information to predict the associated set of barriers and/or motivators.

3. The method of claim 1, further comprising:
defining the factors and interventions for each of the factors; and
training a reinforcement learning (RL) model according to the factors and the interventions for each of the factors.

4. The method of claim 1, in which the associated set of user barriers are relative to purchasing a battery electric vehicle (BEV).

5. The method of claim 1, in which the associated set of user barriers are relative to purchasing a plug-in hybrid electric vehicle (PHEV).

6. The method of claim 1, further comprising:
ranking the plurality of determined interventions to the user; and
selecting the selected one of the plurality of determined interventions according to the ranking.

7. The method of claim 1, further comprising:
predicting the factors regarding the associated set of user barriers; and
determining barriers and/or motivators based on the predicted factors regarding the associated set of user barriers.

8. The method of claim 1, in which presenting comprises:
selecting a highest-ranked barrier;
presenting a highest-ranked intervention corresponding to the selecting of the highest-ranked barrier;
selecting the next highest-ranked barrier;
presenting the highest-ranked intervention corresponding to the next, selected barrier; and
repeating the selecting and presenting until a score threshold or a maximum number of interventions is reached.

9. A non-transitory computer-readable medium having program code recorded thereon for use of elicited factors to inform intervention suggestions, the program code being executed by a processor and comprising:
program code to identify a demographic of a user according to a background of the user;
program code to predict factors including an associated set of barriers and/or motivators regarding a preference according to the demographic of the user;
program code to predict a plurality of interventions to shift the preference of the user according to the associated set of barriers and/or motivators; and
program code to present a selected one of the plurality of determined interventions to the user.

10. The non-transitory computer-readable medium of claim 9, further comprising:
program code to elicit information regarding the associated set of barriers and/or motivators from other users having the background of the user; and
program code to train a model according to the elicited information to predict the associated set of barriers and/or motivators.

11. The non-transitory computer-readable medium of claim 9, further comprising:
program code to define the factors and interventions for each of the factors; and
program code to train a reinforcement learning (RL) model according to the factors and the interventions for each of the factors.

12. The non-transitory computer-readable medium of claim 9, in which the associated set of user barriers are relative to purchasing a battery electric vehicle (BEV).

13. The non-transitory computer-readable medium of claim 9, in which the associated set of user barriers are relative to purchasing a plug-in hybrid electric vehicle (PHEV).

14. The non-transitory computer-readable medium of claim 9, further comprising:
program code to rank the plurality of determined interventions to the user; and
program code to select the selected one of the plurality of determined interventions according to the ranking.

15. The non-transitory computer-readable medium of claim 9, further comprising:
program code to predict the factors regarding the associated set of user barriers; and
program code to determine barriers and/or motivators based on the predicted factors regarding the associated set of user barriers.

16. The non-transitory computer-readable medium of claim 9, in which the program code to present comprises:
program code to select a highest-ranked barrier;
program code to present a highest-ranked intervention corresponding to the selecting of the highest-ranked barrier;
program code to select the next highest-ranked barrier;
program code to present the highest-ranked intervention corresponding to the next, selected barrier; and
program code to repeat the program code to select and the program code to present until a score threshold or a maximum number of interventions is reached.

17. A system for use of elicited factors to inform intervention suggestions, the system comprising:
a demographic identification module to identify a demographic of a user according to a background of the user;
a factor prediction model to predict factors including an associated set of barriers and/or motivators regarding a preference according to the demographic of the user;
an intervention prediction model to predict a plurality of interventions to shift the preference of the user according to the associated set of barriers and/or motivators; and
an intervention presentation module to present a selected one of the plurality of determined interventions to the user.

18. The system of claim 17, further comprising:
a reinforcement learning (RL) model trained according to defined factors and interventions for each of the factors.

19. The system of claim 17, in which the associated set of user barriers are relative to purchasing a battery electric vehicle (BEV).

20. The system of claim 17, in which the associated set of user barriers are relative to purchasing a plug-in hybrid electric vehicle (PHEV).
